(19) United States
(12) Patent Application Publication
(10) Pub. No.: US 2006/0049733 A1
(43) Pub. Date: Mar. 9, 2006

(54) Protected Metal Halide Lamp

(75) Inventor: Lori R. Brock, Ipswich, MA (US)

Correspondence Address: OSRAM SYLVANIA INC, 100 ENDICOTT STREET, DANVERS, MA, 01923, US

(73) Assignee: OSRAM SYLVANIA INC., Danvers, MA (US)

(21) Appl. No.: 10/711,264

(22) Filed: Sep. 7, 2004

(51) Int. Cl. H01J 61/34; H01J 61/52

(52) U.S. Cl. 313/25

(57) ABSTRACT

A high intensity discharge lamp (10a) contains an unshrouded arc tube (14a) mounted in an outer envelope (12a). The outer envelope is surrounded by a protective device (50). The device (50) comprises a translucent pocket (52) constructed of a fine mesh having a strength component sufficient to retain any shards from the outer envelope or arc tube in the event of an arc tube burst and a temperature component sufficient to handle arc tube shards that can have a temperature of ≈1000° C.

### TECHNICAL FIELD

This invention relates to metal halide arc discharge lamps and more particularly to such lamps that carry protection against arc tube bursting.

### BACKGROUND ART

Metal halide arc discharge lamps are frequently employed in commercial usage because of their high luminous efficacy and long life. A typical metal halide arc discharge lamp includes a ceramic, quartz or fused silica arc tube that is hermetically sealed within a borosilicate glass outer envelope. The arc tube, itself is hermetically sealed, has tungsten electrodes sealed into opposite ends and contains a fill material including mercury, metal halide additives and a rare gas to facilitate starting. In some cases, particularly in high wattage lamps, the outer envelope is filled with nitrogen or another inert gas at less than atmospheric pressure. In other cases, particularly in low wattage lamps and lamps with ceramic arc tubes, the outer envelope is evacuated.

It has been found desirable to provide some metal halide arc discharge lamps with a shroud that comprises a generally cylindrical, light-transmissive material, such as quartz, that is able to withstand high operating temperatures. The arc tube and the shroud are coaxially mounted within the lamp envelope with the arc tube located within the shroud. Preferably, the shroud is a tube that is open at both ends. In other cases, the shroud is open on one end and has a domed configuration on the other end. Shrouds for metal halide arc discharge lamps are disclosed in U.S. Pat. No. 4,499,396 issued Feb. 12, 1985 to Fohl et al. and U.S. Pat. No. 4,580,989 issued Apr. 8, 1986 to Fohl et al. See also, U.S. Pat. No. 4,281,274 issued Jul. 28, 1981 to Bechard et al.

The shroud has several beneficial effects on lamp operation. In lamps with a gas-filled outer envelope, the shroud reduces convective heat losses from the arc tube and thereby improves the luminous output and the color temperature of the lamp. In lamps with an evacuated outer envelope, the shroud helps to equalize the temperature of the arc tube. In addition, the shroud effectively reduces sodium losses and improves the maintenance of phosphor efficiency in metal halide lamps having a phosphor coating on the inside surface of the outer envelope. Finally, the shroud improves the safety of the lamp by acting as a containment device in the event that the arc tube bursts. The shrouded lamps can be used in open fixtures. Such lamps have received their own classifications and have been highly successful. However, the lamps are expensive to manufacture and equivalent lamps without the shroud and heavy outer envelope are about 40% less expensive to make.

Accordingly, it would be an advance in the art if less expensive burst protection could be afforded to regular lamps.

### SUMMARY OF THE INVENTION

It is, therefore, an object of the invention to obviate the disadvantages of the prior art.

It is another object of the invention to enhance the burst protection of arc discharge lamps manufactured without a shroud.

It is another object of the invention to provide lamps that can be used in open fixtures.

It is a further object of the invention to provide an inexpensive protection device for lamps.

Yet another object of the invention is the provision of a testing method for arc discharge lamps.

These objects are accomplished, in one aspect of the invention, by the provision of a protective device for a high intensity discharge lamp containing an arc tube within an outer envelope, the protection device comprising a translucent pocket formed to fit over the outer envelope of the lamp, the translucent pocket being constructed of a fine mesh having a strength sufficient to retain any shards from the lamp in the event of an arc tube burst.

Further, there is provided by this invention a kit for adding burst protection to a high intensity discharge lamp having an arc tube mounted in an outer envelope, the kit comprising a translucent pocket formed to fit over the outer envelope of the lamp, the translucent pocket being constructed of a fine mesh having a strength sufficient to retain any shards from the lamp in the event of an arc tube burst and a clamp for positioning and holding the mesh on the outer envelope. The kit provides a means for normally unprotected lamps to be protected and used in open fixtures.

Additionally, there is provided a method of testing lamps by causing them to burst in a controlled manner. The method comprises the steps of operating the lamp for a sufficient time to achieve warm-up conditions; focusing a laser on to the arc tube; and energizing the laser at a power and for a time sufficient to cause the arc tube to burst. Preferably, the lamp is mounted within an enclosure and the laser is focused on to the arc tube through a window in the enclosure.

### BRIEF DESCRIPTION OF THE DRAWINGS

FIG. 1 is a perspective view of a prior art protected arc discharge lamp;

FIG. 2 is an elevational view of a protected arc discharge lamp according to an embodiment of the invention; and

### DETAILED DESCRIPTION OF THE INVENTION

For a better understanding of the present invention, together with other and further objects, advantages and capabilities thereof, reference is made to the following disclosure and appended claims taken in conjunction with the above-described drawings.

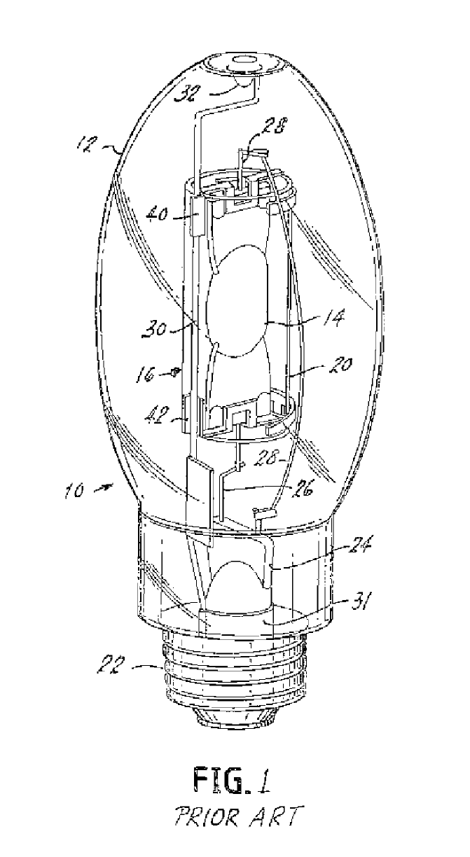

Referring now to the drawings with greater particularity, there is shown in FIG. 1 an exemplary prior art metal halide arc discharge lamp 10 of the type known as protected lamps. The lamp includes a lamp envelope 12 and an arc tube 14 mounted within the envelope by mounting frame 16. The arc tube may be positioned within a shroud 20 which can also be supported by the mounting frame 16. Electrical energy is coupled to the arc tube 14 through a base 22, a lamp stem 24, and electrical leads 26 and 28. The arc tube contains a chemical fill or dose of materials to provide light when an arc is initiated therein, as is known. The shroud 20 comprises a cylindrical tube of light-transmissive, heat-resistant material such as quartz.

As noted, in this particular instance, the mounting frame 16 supports both the arc tube 14 and the shroud 20 within the lamp envelope 12. The mounting frame 16 includes a metal support rod 30 attached to lamp stem 24 by a strap 31. The support rod engages an inward projection 32 in the upper end of the lamp envelope 12. The support rod 30 in its central portion is parallel to a central axis of the arc tube 14 and shroud 20. The mounting means 16 further includes an upper clip 40 and a lower clip 42, which secure both arc tube 14 and shroud 20 to support rod 30. The clips 40 and 42 are attached to the support rod 30, preferably by welding.

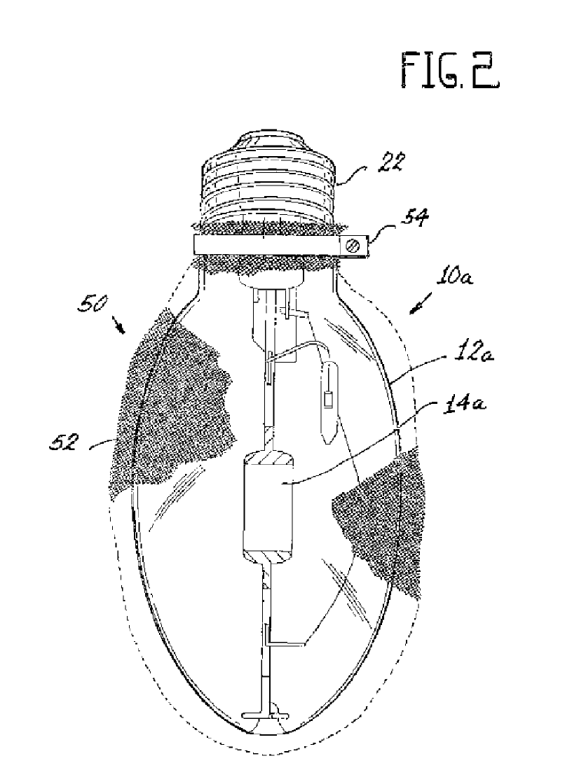

Referring now to FIG. 2 there is shown a high intensity discharge lamp 10a containing an unshrouded arc tube 14a mounted in an outer envelope 12a, the outer envelope being surrounded by a protective device 50. The device 50 comprises a translucent pocket 52 constructed of a fine mesh having a strength component sufficient to retain any shards from the outer envelope or arc tube in the event of an arc tube burst.

The material from which the mesh is constructed or woven must be capable of sustaining the temperatures involved in an operating lamp, and these temperatures can approach ≈250° C. for the outer envelope and more than 1000° C. for fragments of a burst arc tube.

A preferred material for the protective device 50 is a stainless steel screen of 50 mesh/inch, woven of wire having a diameter of 0.0012 inches. Other screen sizes and materials may be appropriate provided they meet the temperature requirements necessitated by the operating lamp. The screen is extremely pliable and easily can be fashioned to accommodate many different lamp shapes.

Inclusion of the protective device 50 will have some effect on the lumen output of the lamp; however, tests have shown such effects to be minimal. For example, tests were run on a 400 watt lamp with and without the protective device 50. The results are shown in Table I below.

TABLE I

| | | % Lumen | |
|---|---|---|---|
| | | Change | |
| | | Device vs. No | Efficacy |
| Description | Lumens | Device | (LPW) |
| No Device - | 40,160 | | 100.4 |
| Try 1 | | | |
| Device On | 37,560 | 6.7 | 93.9 |
| No Device - | 39,630 | 5.4 | 99.1 |
| Try 2 | | | |

For the first try, the lamp was aged for one hour without the protective device and then the light output was measured. Then the protective device was placed over the lamp and held in place with a clamp, the lamp was aged for an additional 15 minutes and the light output was measured again, and finally, the protective device was removed, the lamp was again aged for 15 minutes and the light output measured for the third time, with the results shown in the table as Try 2.

As shown in Table I the protective device lowered the lumen output by only about 6%.

To determine the efficacy of the protective device it is necessary to cause a burst of the arc tube in an operating lamp. A standard method to test the containment of metal halide lamps is the capacitor discharge method which involves discharging a capacitor bank through the lamp; however, a new testing method was developed.

The new testing method comprises mounting a lamp with a protective device in position in a transparent enclosure of, for example plastic. A tray was placed underneath the lamp to catch any fragments or shards. The lamp was then operated for 10 minutes. After the warm-up period a laser was focused upon the arc tube and within 20 seconds the arc tube burst violently, exploding into many pieces. An exhaust system removes all potentially hazardous gases from the enclosure. The outer envelope glass was found to have many cracks and holes; however, there was no damage to the protective device and no pieces of the broken arc tube or outer envelope were observed within the plastic enclosure.

The experiment was conducted with a similar lamp without the protective device and again the arc tube burst and shattered the outer envelope. In the latter test countless pieces of arc tube and outer envelope were found scattered throughout the plastic enclosure.

The laser used in these test was Nd:YAG laser operating at 532 nm. (The normal operating wavelength of the Nd:YAG laser is 1064 nm. Since the infrared output of the laser is difficult to work with, it was doubled to 532 nm, a visible wavelength, using a standard method.) The pulse width was 3 ns and the linewidth was 250 MHz. The repetition rate was 30 Hz and the laser power was ≈100 mJ. The laser beam was focused onto the arc tube using a 500 mm focal length, piano-convex cylindrical lens. The focal plane was therefore line-shaped and oriented vertically along the vertical arc tube wall. The plastic enclosure had a rectangular slot in one of the walls so the laser beam could enter the chamber. When testing the protected lamp it was necessary to provide a slot in the mesh also to allow the laser beam to encounter the arc tube. The slot in the mesh was small (10×3 mm).

This method has an advantage over the capacitive discharge method since the laser allows one to choose where on the arc tube to cause the fracture. Additionally, the capacitive discharge test adds a great amount of energy to the arc tube, thereby increasing the temperature and pressure within the arc tube. This added energy causes a more energetic explosion than observed for actual lamp failures. Since the laser does not add energy to the contents of the arc tube, except in a highly localized area, it offers a more realistic simulation of actual lamp failures. The laser method also offers the possibility of causing small leaks in the arc tube without causing an explosive failure. In this case, a standard piano-convex or biconvex lens (not a cylindrical lens) is used to focus the laser on to the arc tube.

When tested as above, the arc tube of the unprotected lamp burst in as little as 3 to as long as 20 seconds. In the protected lamp, the arc tube burst in about 20 seconds. The laser parameters may be varied widely within this method. For example, a repetition rate of 90 Hz will burst the arc tube three times faster than at 30 Hz. Laser power may also be adjusted to affect the bursting time. A variety of wavelengths may be utilized provided the wavelength is not significantly absorbed prior to reaching the arc tube, e.g., by the glass outer jacket.

There is thus provided a lamp that can be adapted to be used in protected lamp environments after its manufacture, at a cost substantially less than a lamp initially manufactured for such use.

A novel kit is provided allowing an end user to retrofit a lamp for use in situations requiring a protected lamp.

Also, a new method for testing lamps for burst consequences is provided.

While there have been shown and described what are present considered to be the preferred embodiments of the invention, it will be apparent to those skilled in the art that various changes and modifications can be made herein without departing from the scope of the invention as defined by the appended claims.

What is claimed is:

1. A protective device for a high intensity discharge lamp containing an arc tube within an outer envelope comprising:
a translucent pocket formed to fit over said outer envelope of said lamp, said translucent pocket being constructed of a fine mesh having a strength sufficient to retain any shards from said lamp in the event of an arc tube burst.

2. The protective device of claim 1 wherein said fine mesh is stainless steel.

3. The protective device of claim 2 wherein said fine mesh is 50 mesh per inch.

4. The protective device of claim 3 wherein said mesh is constructed of wire having a diameter of 0.0012 inches.

5. A kit for adding burst protection to a high intensity discharge lamp having an arc tube mounted in an outer envelope, said kit comprising:
a translucent pocket formed to fit over said outer envelope of said lamp, said translucent pocket being constructed of a fine mesh having a strength sufficient to retain any shards from said lamp in the event of an arc tube burst; and
a clamp for positioning and holding said mesh on said outer envelope.

6. A protected high intensity discharge lamp having an arc tube mounted in an outer envelope comprising:
a translucent pocket formed to fit over said outer envelope of said lamp, said translucent pocket being constructed of a fine mesh having a strength sufficient to retain any shards from said lamp in the event of an arc tube burst, said translucent pocket being fixed to said lamp outer envelope.

7. A method for bursting the arc tube of a high intensity discharge lamp comprising the steps of:
operating said lamp for a sufficient time to achieve warm-up conditions;
focusing a laser on to said arc tube; and
energizing said laser at a power and for a time sufficient to cause said arc tube to burst.

8. The method of claim 7 wherein said laser is a Nd:YAG laser.

9. The method of claim 8 wherein said laser is operated at 532 nm with a pulse width of laser radiation of 3 ns; a line width of 250 MHz; a repetition rate of 30 Hz and a power of about 100 mJ.

10. The method of claim 9 wherein said laser is focused onto said arc tube via a 500 mm focal length, piano-convex lens.

11. The method of claim 7 wherein the lamp is mounted within an enclosure and the laser is focused on to the arc tube through a window in the enclosure.
